(19) United States
(12) Patent Application Publication
(10) Pub. No.: US 2011/0036096 A1
(43) Pub. Date: Feb. 17, 2011

(54) INTEGRATED GASIFICATION COMBINED CYCLE (IGCC) POWER PLANT STEAM RECOVERY SYSTEM

(75) Inventors: Sampath Kumar Bommareddy, San Diego, CA (US); Douglas Kirk Holland, Montgomery, TX (US); Charles Michael Jones, Ballston Lake, NY (US); Darrin Glen Kirchhof, Schenectady, NY (US); James Michael Storey, Houston, TX (US); Leroy Omar Tomlinson, San Diego, CA (US)

Correspondence Address: CANTOR COLBURN LLP, 20 Church Street, 22nd Floor, Hartford, CT, 06103, US

(73) Assignee: GENERAL ELECTRIC COMPANY, Schenectady, NY (US)

(21) Appl. No.: 12/540,789

(22) Filed: Aug. 13, 2009

(51) Int. Cl. F01K 23/10; F02C 3/28; F02C 6/04; F01K 19/00; F01K 23/16

(52) U.S. Cl. 60/780; 60/645; 60/39.12; 60/39.5; 60/670; 60/676

(57) ABSTRACT

In an integrated gasification power plant a steam recovery system is provided. The system enables power generation equipment designed for a predominant fuel and operating condition to efficiently utilize additional steam generation by syngas coolers when heat transfer surface condition or fuel characteristics enable additional steam generation. The system can detect excess steam generation, integrate it with the syngas cleaning process and transmit it to the power generation equipment. The system results in a low cost power generation system which is capable of efficiently operating with a wide range of fuels and a wide rang of operating conditions.

### BACKGROUND OF THE INVENTION

The subject matter disclosed herein relates to a plant steam system for use with an Integrated Gasification Combined Cycle (IGCC) plants utilizing various coal petroleum coke, gas, or liquid fuel ranges and taking into account fouling characteristics of the Syngas Cooler (SGC) to improve installed cost and performance

In IGCC plants, clean syngas is produced from partial oxidation of solid or liquid fuels to generate power in a combined cycle application that is integrated for heat recovery with a gasification island. The plants typically include a process island, that is responsible for syngas production, steam generation, water treatment, syngas cleanup and sulfur removal; and a power island, that includes one or more gas turbines and Heat Recovery Steam Generators (HRSG), steam turbine, cooling tower and condenser which operates in accordance with typical combined cycle applications. The heat integration, in which steam is exported to the power island from the process island and feedwater is exported from the power island to the process island to improve cost and performance, is a key criteria for IGCC plant design.

In gasification processes, the heat from hot syngas, (at approximately 2000°-2500° F., exiting the gasifier is recovered by an SGC, which generates high pressure saturated steam. This syngas passing through the SGC is dirty syngas which contains ash particulates, sulfur in gaseous form, chlorides and some trace metals, which contribute to forming of a fouling layer on an SGC shell and heat transfer surface which degrades its heat transfer capability. Fouling typically increases as a function of operating time, and a significant amount of the lost heat transfer capability can be recovered by a shutting down and restarting the gasifier, which results in knocking off the thick particulate layer attached to the heat transfer surfaces. The result is a new and clean mode of operation, whereupon fouling will begin again. It has been found that 50-60% of the lost heat transfer can be recovered (also referred to as recoverable degradation) on a hot restart of the gasifier. The high pressure, saturated steam from the SGC (which is typically designed for approximately 2000-2500 psig) is transmitted to the HRSG where it is superheated prior to admission to the steam turbine.

Traditionally IGCC plant heat integration between process and power islands has been based on the heat transfer capability of fouled syngas coolers and does not take into account increased steam generation capacity of relatively new and clean surfaces, a fouling rate and/or a recoverable degradation. The relatively new and clean scenarios have, in past practice, described an operational mode in which steam was vented to the atmosphere or the plant was operated at a partial load condition. Here, for every restart of a gasifier when degraded heat transfer capability was recovered, the excess steam was vented. This resulted in wasted energy and inefficiencies.

Moreover, it has been seen that IGCC plants are typically designed to handle and to be designed only for operational firing of a single grade of coal, petcoke or oil fuel. Excess heat or steam is typically vented, decreasing the efficiency of a plant. The growing demand for flexibility in utilization of a wide range of fuels in IGCC plants results in varied steam production. Process demand and generation by equipment and systems in process islands during startup and normal operating scenarios varies greatly over a single cycle due to fouling and varying fuel characteristics used. The variation of fuels in current plant designs will result in even less efficient use of the heat generated, since the plants do not have the flexibility to utilize different levels of heat and steam during a single operating cycle. It is important that plants have the ability to better utilize the heat generated over a wide range of fuels and operating conditions in a continuous manner in a single cycle.

### BRIEF DESCRIPTION OF THE INVENTION

A system in an integrated gasification combined cycle plant is provided in which a balance of cost and performance is achieved by a steam recovery system that integrates the energy recovered by cooling the syngas into the power generation system, allowing the system to operate efficiently over a wide range of operating conditions.

According to one aspect of the invention, a plant steam recovery system in an integrated gasification combined cycle power plant is provided. It comprises a gasifier to provide a fuel supply to a gas turbine and a radiant syngas cooler for cooling the fuel supply exiting the gasifier, the syngas cooler producing steam and being fluidly connected to a high pressure steam drum, a low pressure flash drum and a medium pressure flash drum. A pressure transmitter for detecting excess steam from the high pressure steam drum is also provided. A steam header is fluidly connected to the high pressure steam drum and the medium pressure steam drum and directs the excess steam to the medium pressure flash drum.

According to another aspect of the invention, a method of recovering excess steam in syngas production in an integrated gasification combined cycle plant is provided. It comprises recovering high pressure steam during a clean mode of operation of the plant, recovering low pressure steam during a fouled mode of operation and detecting excess steam during the clean mode of operation of said plant. Once detected, the excess steam is directed to a medium pressure condensate collection drum and further utilized in the plant.

The system in this invention enables the integration of the heat recovered from the syngas by the syngas coolers and LTGC to be utilized for the normal operation of the IGCC plant, in which the syngas coolers are in a fouled state, while enabling effective utilization of all of the heat recovered from the syngas when the SGC is in a clean condition. The system also provides flexibility in operation such that a system that is intended for a specific coal, petcoke or oil fuel will have the capability to utilize the heat recovered from the syngas effectively in both the process island and the electrical power generation island when operating with a wide range of solid or liquid fuels.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of an IGCC power plant;

FIG. 2 is a schematic illustration of one aspect of the steam recovery system of the present invention.

The detailed description explains embodiments of the invention, together with advantages and features, by way of example with reference to the drawings.

### DETAILED DESCRIPTION OF THE INVENTION

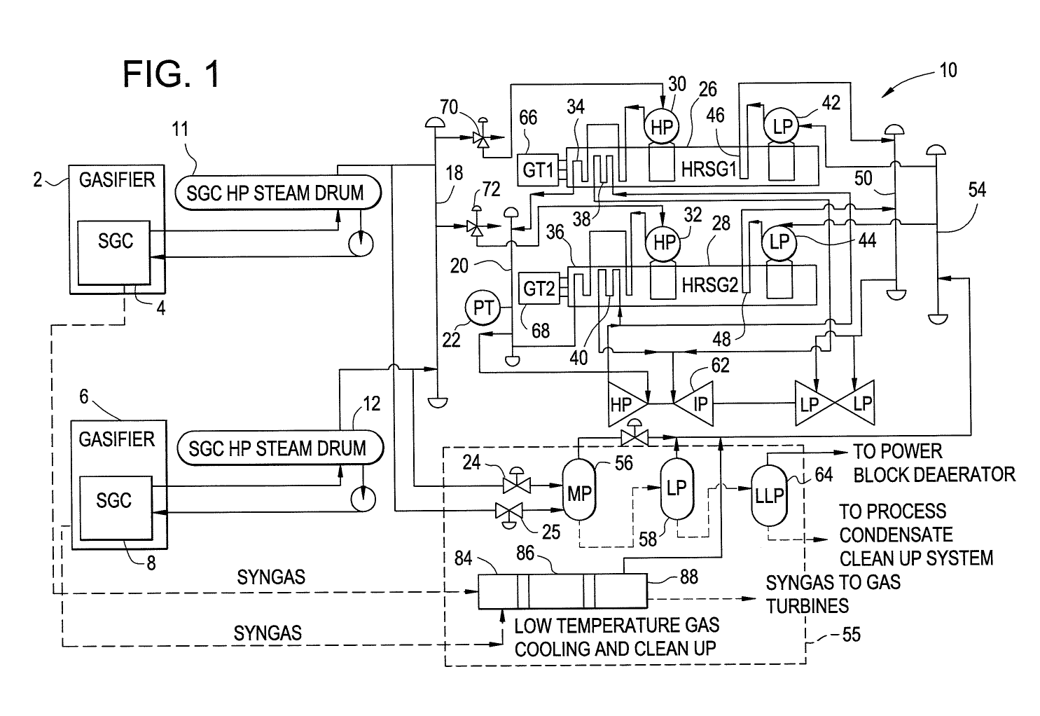

Referring now to FIG. 1, an overview of the gasification process will now be described. In the gasification process, the dirty syngas discharges from a gasifier 2, 4 at approximately 2000° F. to 2500° F. temperature and it is required to be cooled to approximately 100° F. prior to the cleanup process. The syngas cooling is accomplished in three stages: (1) high temperature cooling in a syngas cooler (SGC) 4, 8 by generating high pressure (HP) saturated steam in a syngas cooler high pressure steam drum (SGC HP steam drum) 11, 12, (2) quenching and scrubbing for cooling and particulate removal by direct contact with water, and (3) low temperature gas cooling (LTGC) by generation of low pressure (LP) saturated steam in syngas cleanup systems 84, 86 and 88. The HP saturated steam generated by the syngas coolers 4, 8 is supplied to the combined cycle power generation equipment where it is superheated by the Heat Recovery Steam Generators (HRSG) 26, 28 and admitted to a high pressure section of a steam turbine generator unit 62, which generates electrical power. The LP steam generated by the LTGC system is utilized primarily in the syngas cleaning process and excess steam is admitted to a HRSG LP section 42, 44, where it is superheated and admitted to a LP section of the steam turbine 62.

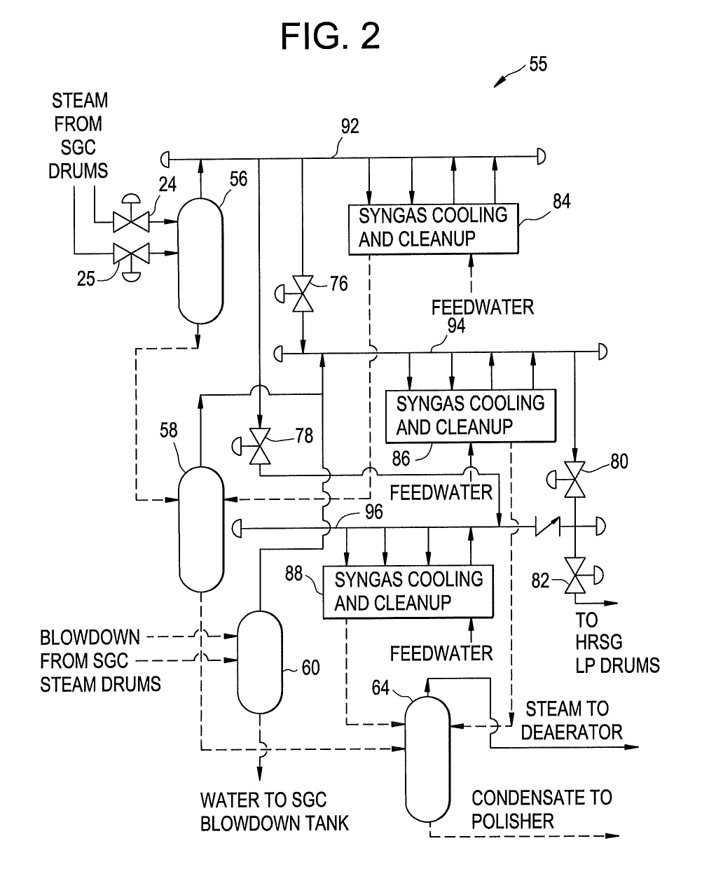

Referring now to FIGS. 1 and 2, in which like numerals indicate like features, FIG. 1 illustrates a multiple unit, Integrated Gasification Combined Cycle (IGCC) power plant 10. The IGCC power plant 10 includes first and second gasifier systems 2 and 6, which may accept a wide range of solid or liquid fuels to thereby provide by partial oxidation a synthetic gaseous (syngas) fuel supply to a first and a second gas turbine system 66 and 68 after it is cooled in the syngas coolers 4 and 8, and further cooled and cleaned in the low temperature gas cooling and cleanup systems 84, 86 and 88.

The syngas coolers 4 and 8 generate high pressure saturated steam in a range of about 2000 psig to 2500 psig and about 2000 psig while performing the high temperature phase of syngas cooling. During a new and/or clean gasification cycle, typically after a hot restart of the gasifiers 6 and 8, the SGC steam production may exceed the capacity of the HP section of the steam turbine. The SGC steam is supplied to the medium pressure drum 56. The SGC steam during this time originates from SGC HP steam drums 11, 12 and a SGC header 18 from which it is apportioned by valves 70 and 72 to the HRSG high pressure drums 30 and 32.

Further the IGCC Plant 10 includes the gas turbines 66 and 68. Each gas turbine system includes a combustion system and a gas turbine. The gas turbines are coupled to and drive generators to produce electricity. The power plant 10 further includes a steam turbine system 62 that also drives a generator that produces additional electrical power.

The exhaust gas from gas turbines 66 and 68 is ducted to heat recovery steam generators 26 and 28. A HRSG is a counter flow heat exchanger having a heat transfer duct containing heat transfer tubes. Feed water passes through the heat transfer tubes and is heated by hot gas turbine exhaust gas exiting gas turbines 66 and 68. The heat recovery steam generators 26, 28 include low pressure evaporators and steam drums 42 and 44, low pressure superheaters 46 and 48, high pressure evaporators and steam drums 30 and 32, high pressure superheaters 34 and 36, and reheaters 38 and 40. The high pressure evaporators 30, 32 receive steam from the SGC steam header 18 which is generated by the syngas coolers 4 and 8 and SGC steam drums 11 and 12.

During operation the first and second gasifier systems 2 and 6 produce syngas fuel for first and second gas turbine systems 66 and 68. The temperature of the gas discharging from the gasifiers 2 and 6 is in a range of about 2000° F. to 2500° F. The initial phase of syngas cooling is accomplished by the syngas coolers 4 and 8 which evaporate part of the saturated water supplied from the steam drums 11 and 12 and return the water/steam mixture to the steam drums where the steam is separated from the water, thus generating the above mentioned saturated steam in a range of about 2000 psig to 2500 psig.

The steam from the SGC drums 11 and 12 is supplied to the SGC header 18. Thereafter, it is supplied to the medium pressure steam drum 56 and to the HRSG HP steam drums 30 and 32 through valves 70 and 72 which normally control the steam pressure in SGC header 18 and apportion the steam to each HRSG drum 30, 32 proportional to the capability of each HRSG to superheat and reheat the SGC steam. The steam is superheated by the HRSG HP superheaters 34 and 36 and supplied to the HP superheated steam header 20.

The HP steam is supplied from the superheated steam header 20 to the HP section of the steam turbine 62 which drives a generator to produce electrical power. The steam exhausts from the HP section of steam turbine 62 and is transmitted to the HRSG reheaters 3 8 and 40. The reheaters 3 8, 40 heat the steam to a temperature about the same as the superheated steam temperature. The steam is returned to the immediate pressure section of steam turbine 62.

After the initial cooling by the syngas coolers 4 and 8 the syngas is piped to the low temperature gas cooling and cleanup systems 84, 86 and 88 for further cooling and cleaning. The heat recovered from the syngas generates low pressure steam which is used primarily in the cleanup process and the excess is admitted to the HRSG LP steam drums 42 and 44.

With reference to FIG. 1 and referring now to FIG. 2, a medium pressure heat recovery system 55 supplies steam to the medium pressure condensate collection drum 56 from the SGC steam drums 11 and 12, that is pressure reduced by valves 24 and 25 to a range of about 500 psig to 900 psig. This medium pressure steam, as will be further described herein, can then be apportioned across the power island, improving the overall efficiency of the IGCC plant 10.

Steam from the medium pressure condensate collection drum 56 is supplied to the medium pressure header 92 which distributes steam to the syngas cleanup system 84, supplies steam through valve 76 to a second process steam header 94 that operates in a range of about 85 psig to about 110 psig and supplies steam through valve 78 to a third process steam header (or low pressure steam header) 96 that in a range of about 50 psig to 80 psig. Condensate from the medium pressure flash drum 56 is drained to the low pressure flash drum 58.

Low Pressure flash drum 58 collects the condensate from the heat exchangers and equipment in the medium pressure heat recovery system 55 of the gas cooling and cleaning system and receives the condensate from the medium pressure flash drum 56. The steam flashed from the condensate collected in low pressure flash drum 58 is supplied to the second steam header 94.

Steam is distributed from the second steam header 94 to the gas cleaning process equipment 86 that operates at a compatible pressure with second steam header 94, and it collects steam from the process equipment that generates steam and from the low pressure flash drum 58. If the steam generation by the syngas cooling and cleaning equipment is insufficient to satisfy the demand by steam users on this header, supplemental steam is supplied from the medium pressure steam header 92 through valve 76. If steam generation exceeds the steam demand of the steam using equipment on this header, excess steam is passed to the HRSG LP steam drums 42 and 44 through valves 80 and 82.

The third steam header 96 that operates in a range of 50 psig to 80 psig distributes steam to the syngas cleaning equipment 88 that operates at compatible pressure and it collects steam from the syngas cooling and cleaning equipment that generate steam and from the SGC blowdown flash drum 60. If steam generation by the syngas cooling and cleaning equipment 88 is insufficient to satisfy the steam users on this header, supplemental steam is supplied from the medium pressure header 92 through valve 78. If steam generation exceeds the demand of steam using equipment on this header 92, excess steam is discharged to the HRSG LP steam drums 42 and 44 through valve 82.

A further flash drum 64 is provided to collect the condensate from the low pressure flash drum 58 and equipment on the third steam header 94 and the second steam header 96. Flash drum 64 operates in a range of about 10 psig to about 40 psig. Pressure and steam flashed from flash drum 64 is supplied to the plant deaerator. Condensate drained from flash drum 64 is pumped to a polishing demineralizer for cleanup prior to admitting it to the plant deaerator.

The invention reduces the cost of the steam turbine generator unit 62 and improves its performance during the predominant operating period while enabling utilization of the steam generated by the syngas coolers 4, 6 and low temperature gas cooling cleanup systems 84, 86 and 88 when operating with fuel with differing steam generation characteristics or with the syngas coolers 4, 8 in a new or clean operating condition. The steam turbine capacity is that required for the predominant fuel and operation with fouled syngas coolers 4, 8 and the performance is designed for this operating condition. The steam flow capacity of the steam turbine 62 HP section is exceeded by the higher steam generation of the syngas coolers 4 and 8 with a clean heat transfer surface or with a fuel with characteristics that increase the steam generation by syngas coolers 4 and 8. The steam recovery system, and specifically the medium pressure heat recovery system 55 enables the excess steam generated by syngas coolers 4 and 8 to be utilized in the gas cooling and cleaning process 84, 86 and 88 and the LP section of the steam turbine 62.

In addition, a lower cost of operation of the heat recovery steam generators 26 and 28 is realized by setting the capacity of the HP superheaters 34 and 36 and reheaters 38 and 40 to that compatible with the HP steam generation capability of the syngas coolers 4 and 8 when operating with the predominant fuel and in the fouled condition. When steam generation by syngas coolers 4 and 8 is detected that exceeds the superheating and reheating capability of the heat recovery steam generators 26 and 28, the steam recovery system, and specifically the medium pressure heat recovery system 55 enables the excess steam to be utilized in the low temperature gas cooling and cleaning process 84, 86, and 88 and the LP section of steam turbine 62.

The invention also has the ability to effectively utilize the capacity of the LP section of the steam turbine 62 when the steam generated by the low temperature gas cooling clean up system 84, 86 and 88 is reduced, such as when the syngas coolers are operating in a new and/or clean condition. It will be appreciated that the low temperature gas cooling steam production is reduced when the syngas coolers 4, 8 are new or clean because the added heat recovered from the syngas reduces the heat available to the low temperature gas cooling for generating LP steam. The medium pressure heat recovery system 55 enables the transfer of excess steam from the SGC steam header 18 for utilization of the low temperature gas cooling and cleaning system 84, 86 and 88 and for fully loading the LP section of steam turbine 62.

In operation the steam turbine 62 operates with sliding pressure in the HP steam header 20. In this mode, steam turbine 62 operates with its HP steam control valve (not shown) fully open so that the steam header pressure is controlled passively by the flow resistance of the steam turbine first stage nozzle (also not shown) so that the pressure varies directly proportional to HP steam flow. This mode of operation enables the detection of steam turbine operation at maximum steam flow through the HP section by sensing the steam pressure in the superheated steam header 20 by pressure transmitter 22.

A pressure transmitter 22 detects when steam flow to steam turbine 62 HP section is higher than its flow capability. Thereafter, control of the HP superheated steam header pressure is transferred to valves 24 and 25 which control flow to medium pressure drum 56. Valves 24 and 25 control superheated steam header pressure by passing the excess steam flow from the SGC steam header 18 that would otherwise be transmitted to the superheated steam header 20 through the HRSG superheaters 34 and 36, to the medium pressure steam drum 56. Simultaneously, control of the steam pressure in medium pressure steam header 92 is transferred to valve 78 that passes excess steam flow to the third steam header 96. Since the low temperature gas cooling LP steam generation is reduced when increased HP steam is generated by syngas coolers 4 and 8, the added steam from medium pressure header 92 may be required by the low temperature gas cooling system. However, if the added steam flow to header 96 exceeds the low temperature gas cooling requirement and results in an increase in steam pressure in this header, excess steam is passed to the HRSG LP steam drums 42 and 44 through valve 82 that controls the steam pressure in header 96.

The steam admitted to the HRSG LP drums 42 and 44 is superheated in the LP superheaters 46 and 48 and admitted to the LP sections of steam turbine 62 thus utilizing excess steam generation by syngas coolers 4 and 8 to fully load the LP section of steam turbine 62. Thus, the steam recovery system in this invention balances the steam requirements of the low temperature gas cooling and enables utilization of the LP steam turbine capacity that would have otherwise been underutilized because of the reduced LP steam generation by the low temperature gas cooling.

There is potential for the steam generation capability of syngas coolers 4 and 8 to exceed the capability of the HRSG HP superheaters 34 and 36 and the reheaters 38 and 40 to superheat and reheat the saturated steam generated by syngas coolers 4 and 8. The capability of either HRSG 34 or 36 to superheat and reheat steam is calculated by a control system (not shown) based on the quantity of energy received from first and second gas turbines 66 and 68, for superheating and reheating steam from the syngas coolers 4 and 8.

When steam flow from syngas coolers 4 and 8 exceeds the capacity of the heat recovery steam generators 34, 36 to superheat and reheat SGC steam is sensed by pressure transmitter 22, steam flow apportioning valves 70 and 72 will limit flow to the HRSG drums 30 and 32. Control of the pressure in SGC steam header 18 is then transferred from valves 70 and 72 to valves 24 and 25, which direct steam to medium pressure steam drum 56 to control the steam pressure in the SGC steam header 18. Thereafter, effective utilization of HP steam admitted to medium pressure condensate collection drum 56 limits steam flow to the HRSG HP superheaters 38 and 40 in the manner described above.

In accordance with the above description, a plant steam recovery system in an integrated gasification combined cycle power plant 10 is provided. It integrates the low temperature gas cooling and cleanup system 84, 86 and 88 with the syngas cooler 4, 8, heat recovery steam generator 26, 28, and steam turbine 62 to enable a low cost IGCC power plant 10 to operate efficiently over a range of operating conditions and with a range of fuel characteristics. Specifically, the medium pressure steam drum 56 and medium pressure steam header 92, two low pressure steam headers 94, 96, a low pressure steam drum 58, a low pressure condensate flash drum 64, interconnecting piping, control valves, and control system that are fluidly coupled and integrated with the syngas coolers 4, 8, low temperature gas cooling and cleanup system 84, 86, 88, heat recovery steam generators 26, 28 and steam turbine 62 allow economical integration of steam in an integrated gasification power plant 10. Plant 10 maintains the ability to operate in its most predominant operating condition (fouled) and with a preselected fuel, while still enabling plant 10 to operate effectively and efficiently when conditions or fuel enable the generation of additional steam by the syngas coolers.

It will be appreciated that the system contemplates use of a control system and control logic, together with the pressure transmitter 22 for detecting an excess steam production by syngas coolers 4, 8 greater than the capacity of the high pressure section of the steam turbine 62. Such a system would include sensors, control system, and logic for calculating the capability of heat recovery steam generators to superheat and reheat saturated steam received from syngas coolers. Such calculation is based on the quantity and quality of energy received from gas turbines and the heat recovery steam generator operating conditions. The control system would control the transfer of steam from syngas coolers, integration with the low temperature gas cooling and cleanup system and direction of excess steam to a low pressure section of a steam turbine to achieve steam turbine power generation over a wide range of operating conditions without venting steam or otherwise wasting energy.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A steam recovery system in an integrated gasification combined cycle power generation plant that integrates the steam distribution and collection system associated with the low temperature syngas cooling and cleanup system with its syngas coolers, multi-pressure heat recovery steam generators and steam turbine such that the steam turbine and heat recovery steam generators can be optimized for cost and performance for a predominant operating condition (fouled syngas cooler heat transfer surface) and a specific gasifier fuel characteristic, and which maximizes efficient power generation when the steam generation by the syngas coolers is higher than that for the optimized plant, as for example, when the syngas cooler is clean or when an alternate gasifier fuel characteristic increases the energy available to the syngas cooler, said integrated gasification combined cycle power plant comprising:
at least one gasifier that partially oxidizes solid or liquid fuel to provide a fuel supply to a gas turbine that drives at least one generator for the purpose of electrical power generation and which further supplies hot exhaust gas to at least one high pressure steam drum which generates high pressure steam;
at least one syngas cooler for cooling said syngas fuel supply exiting said at least one gasifier, said syngas cooler producing steam and being fluidly connected to a high pressure steam drum which generates high pressure steam;
at least one low temperature gas cooling and cleanup system with a steam collection and distribution system that collects steam generated by the low temperature syngas cooling system and steam that is pressure-reduced from the syngas coolers, distributes it to the steam consuming components in the syngas cleanup system and too the heat recovery steam generator low pressure steam drums;
at least one heat recovery steam generator that receives hot exhaust gas from the at least one gas turbines which generate high pressure superheated steam and low pressure superheated steam, superheat and reheat saturated steam received from the syngas coolers, and superheat saturated steam received from the low temperature gas cooling and cleanup system, said heat recovery steam generator optimized for cost and performance for a predominant syngas cooler operating condition and gasifier fuel characteristic;
at least one steam turbine which utilizes said steam from said at least one heat recovery steam generator to drive a generator for the purpose of generating electrical power, said steam turbine optimized for cost and performance for a predominant syngas cooler operating condition and gasifier fuel characteristic and operated in a mode such that the high pressure steam pressure varies proportional to the high pressure steam flow;
a pressure transmitter on the steam turbine high pressure steam supply header that detects steam flow exceeding that for which the steam turbine is optimized. excess steam from said high pressure steam drum; and
a steam header fluidly connected to said syngas cooler high pressure steam drum and said medium pressure condensate collection drum and directing said excess steam to said medium pressure condensate collection drum.

2. The plant steam recovery system of claim 1, including a low low pressure flash drum.

3. The plant steam recovery system of claim 2, wherein said low low pressure flash drum operates in the range of about 10 to about 40 psig.

4. The plant steam recovery system of claim 1, including a process condensate clean up system fluidly connected to a deaerator.

5. The plant steam recovery system of claim 1, including a medium pressure header fluidly connected to said medium pressure steam drum and a low pressure header fluidly connected to said medium pressure header.

6. The plant steam recovery system of claim 1, wherein said high pressure steam drum operates in the range of about 2000 psig to about 2500 psig.

7. The plant steam recovery system of claim 1, wherein said high pressure steam drum operates in the range of about 2000 psig.

8. The plant steam recovery system of claim 1, wherein said medium pressure condensate flash drum operates in the range of about 500 psig to about 900 psig.

9. The plant steam recovery system of claim 8, wherein said medium pressure condensate flash drum operates in the range of about 600 psig.

10. The plant steam recovery system of claim 1, wherein said low pressure flash drum operates in the range of about 50 to about 80 psig.

11. The plant steam recovery system of claim 10, wherein said low pressure flash drum operates in the range of about 75 psig.

12. A method of recovering excess steam in syngas production in an integrated gasification combined cycle plant, comprising:
recovering high pressure steam during a clean mode of operation of said plant;
recovering low pressure steam during a fouled mode of operation;
detecting excess steam during said clean mode of operation of said plant;
directing said excess steam to a medium pressure steam drum; and
utilizing said excess steam in said plant.

13. The method of claim 12, including directing said excess steam from said medium pressure steam drum to a syngas cleanup system and utilizing said excess steam for syngas conditioning and processing.

14. The method of claim 12, including letting down said excess steam to a low pressure header and merging with steam from a low pressure flash drum and directing said merged steam to a heat recovery steam generation low pressure steam drum and utilizing said merged steam in a steam turbine.

15. The method of claim 12, including directing condensate from said medium pressure steam drum to a low pressure flash drum and further directing a steam flashed from said condensate to a syngas cleanup system and utilizing at least a portion of said steam for syngas conditioning and processing.

16. The method of claim 15, including discharging steam from said low pressure flash drum and directing said steam to a heat recovery steam generator low pressure steam drum and utilizing said steam from said low pressure steam drum in a steam turbine.

17. The method of claim 12, including operating said medium pressure steam drum in the range of about 500 psig to about 900 psig.

18. The method of claim 17, including operating said medium pressure steam drum in the range of about 600 psig.

19. A steam recovery system in an integrated gasification combined cycle power plant comprising:
at least one gasifier to provide a syngas fuel supply to at least one gas turbine that drives at least one generator for the purpose of electrical power generation and which further supply hot exhaust gas to at least one heat recovery steam generator;
at least one syngas cooler for cooling said syngas fuel supply exiting said gasifier, said at least one syngas cooler including a high pressure steam drum which generates high pressure saturated steam;
at least one low temperature gas cooling and cleanup system that generates low pressure steam for use in a cleanup process and in a low pressure section of said at least one heat recovery steam generator, said at least one heat recovery steam generator receiving a hot exhaust gas from said at least one gas turbine which generates high pressure superheated steam and low pressure superheated steam; and
at least one steam turbine which utilizes the steam from said at least one heat recovery steam generator to drive said at least one generator.

20. The steam recovery system of claim 19, including a medium pressure flash drum fluidly connected to said high pressure steam drum and a medium pressure header, said medium pressure header fluidly connected to a low pressure header.
